(19) United States
(12) Patent Application Publication
(10) Pub. No.: US 2022/0097167 A1
(43) Pub. Date: Mar. 31, 2022

(54) METHOD FOR DIFFUSION JOINING AND DEVICE THEREFOR WITH PRESSURE VARIATION

(71) Applicant: Nils HANEKLAUS, Bayreuth (DE)

(72) Inventor: Nils HANEKLAUS, Bayreuth (DE)

(21) Appl. No.: 17/425,625

(22) PCT Filed: Jan. 23, 2020
(86) PCT No.: PCT/EP2020/051630

§ 371 Date: Jul. 23, 2021

(30) Foreign Application Priority Data
Jan. 25, 2019 (DE) 10 2019 101 860.9

(51) Int. Cl. B23K 20/02; B23K 20/227; B23K 20/233

(52) U.S. Cl. CPC B23K 20/025; B23K 20/026; B23K 2103/05; B23K 20/2336; B23K 20/227

(57) ABSTRACT

A method for diffusion joining by way of a first and a second stamp, wherein plate-like joining parts are arranged between the two stamps. A pressure is applied to the joining parts by way of the first and/or the second stamp for the purpose of diffusion joining. In addition, a variation of the pressure is also introduced. The pressure and the pressure variation are applied via the first stamp, whereas the second stamp can be rigid. Further disclosed is a device for carrying out the method.

The invention relates to a method for diffusion joining, in which a first and a second stamp are used. At least two plate-like joining parts are arranged between the first and the second stamp with a joining plane between the at least two joining parts. For the diffusion joining, by means of the first and/or the second stamp, a pressure is further applied substantially perpendicular to the joining plane to the at least two joining parts. In addition, provision is additionally made for a pressure variation to be applied to the pressure.

Furthermore, the invention relates to a device for diffusion joining, in particular for carrying out a diffusion joining method. The device has a first and a second stamp, wherein at least two plate-like joining parts can be arranged between the first and the second stamp with a joining plane between the at least two joining parts. A pressure generating apparatus for applying a pressure substantially perpendicular to the joining plane to the at least two joining parts by means of the first and/or the second stamp is provided. The pressure generating apparatus is also designed to vary the pressure.

In diffusion joining, two components to be connected, which are normally plate-like, are laid on each other. The contact area of these two plate-like joining parts is designated as a joining plane. In principle, the joining parts can also be designated as a semifinished product or the like. In order to make the connection between the two joining parts, pressure is applied to the two joining parts, normally substantially perpendicular to the joining plane. Ideally, a connection is produced between the two joining components at the joining plane, which components have similar or the same properties as the basic materials.

Diffusion joining can be implemented not only with two joining parts but also with a multiplicity of joining parts arranged in the manner of a stack. The result is then a composite-like structure.

In order to carry out common diffusion joining methods, the at least two joining parts are normally arranged on or between two stamps. These two stamps are moved in the direction toward each other via a pressure generating apparatus, so that pressure is applied to the joining components, ideally substantially perpendicular to the joining plane. This then leads to the diffusion joining, so that a connection similar to a weld is produced at the joining plane between the two joining components.

Diffusion joining methods have already been known for a long time, for about 50 years. Over the course of time, various theories about the exact properties and changes during the diffusion joining have been presented.

One common theory subdivides the diffusion joining into a three-stage process.

In the first of these stages, microscopic deformations on the surface of the two joining points at the joining plane are reduced or eliminated by plastic deformation as a result of the contact pressure. Here, it is assumed that initially point-like points of contact are enlarged by plastic deformation until a substantially continuous contact area is formed. The local stress in the materials falls below the yield stress, so that the formation of an ideal surface is promoted. There are normally still oxide layers present in the joining plane on the joining components. These constitute an obstacle to diffusion joining. In the first stage, it is also assumed that these oxide layers are blown apart during the plastic deformation and are still present on the surface as coarse clods but are no longer continuous.

At the same time as the first stage, diffusion-controlled creep processes already take place at planar locations and additionally lead to enlargement of the boundary contact areas and therefore to the closure of cavities that are present.

In the last stage, it is assumed that remaining gaps are closed or ultimately become closed by volume diffusion. By means of further reshaping and diffusion processes, the former boundary surfaces which lay in the joining plane are cancelled out and a connection is produced between the two joining parts, which is designated as a welded connection. To some extent, there are also re-crystallized areas here.

One important point which is necessary for the successful performance of a diffusion joining method is breaking up the above-described oxide layers. Although this can also be done by the pure pressure and by the corresponding reshaping processes, it is also known that breaking up the oxide layers is improved by a variation in the pressure.

One method in this connection is described, for example, in CN 105 689 884 A. Here, the basic pressure is applied to the joining parts via a first stamp. An axial oscillation is introduced via a further stamp by means of an ultrasonic tool head. This is intended to lead to a sufficient pressure variation.

A similar method is known from JPS 61229485 A. Here, too, the pressure variation is introduced via an ultrasonic tool head, which is located opposite the actual stamp. Also known from this document is that, by increasing the initial pressure, the pressure variation is superimposed starting from a certain pressure and no longer has to be measured at the joining parts.

The invention is therefore based on the object of specifying a method and a device for diffusion joining in which a simple structure is provided, which are to be used efficiently and which produce a high quality connection between the joining components.

According to the invention, this object is achieved by a method for diffusion joining having the features of claim 1 and a device for diffusion joining having the features of claim 7.

Advantageous embodiments of the invention are specified in the sub claims, in the description and in the FIGURE and the explanation thereof.

According to the invention, a generic diffusion joining method is developed in that the pressure and the pressure variation are applied to the at least two joining parts via the first stamp, wherein the pressure variation is introduced in the pressing direction. Here, provision is also made for the second stamp to be used as a rigid anvil-like stamp. In addition, the minimum pressure which is applied by means of the pressure variation is chosen to be between 25% and 75% of the maximum pressure.

The invention is substantially based on two basic ideas. The first basic idea can be seen in the fact that both the pressure and the pressure variation are applied to the at least two joining parts via the same stamp, which means via the same device. The result of this is that in particular the problems which are known from the prior art, that the pressure variation, if it is applied via another component, no longer arrives at the joining plane with sufficient intensity above a certain basic pressure, no longer occur.

Since the pressure variation is introduced directly via the same stamp as the pressure, it is relatively simply ensured that the variation is also present at the joining plane. This, in turn, has considerable effects on the rapidity and quality of the removal or breaking up of the oxide layers. Overall, the result of this is that, with the method according to the invention, diffusion joining can be carried out considerably more quickly than with conventional methods. In addition, a higher quality of the welded connections between the two joining parts is made possible, since breaking up and removing the oxide layers is achieved particularly well.

In this connection, the second basic idea can also be seen. Since, according to the invention, the pressure and the pressure variation are introduced via the same stamp, the second stamp can be designed rigidly, for example in the form of an anvil-like stamp. In other words, only one stamp has to be movable or designed to have pressure applied. This reduces the outlay on design and control for such a system. This applies particularly clearly if the diffusion joining method is carried out in a chamber which, for example, can be evacuated. Here, it is necessary to provide appropriate seals on all the components that can be moved in the chamber. With the method according to the invention, only one seal has to be provided for the movement of the first stamp, since the second stamp is rigidly designed.

In an advantageous embodiment, a range from 0.5 Hz to 200 Hz is chosen for the frequency of the pressure variation. Here, it has been found that this relatively low frequency in particular causes adequately good blowing apart of the oxide layers. If a higher frequency is used then, according to the findings of the invention, this is not reliably the case.

In principle, the pressure variation can be chosen as desired. The basic pressure which is used for a diffusion joining method depends substantially on the materials to be connected. Thus, for example, when connecting materials such as aluminum alloys, a pressure between 1 MPa and 5 MPa is normally used. On the other hand, when connecting two joining parts made of stainless steel, a pressure in the range from 15 MPa to 20 MPa is used. Still higher pressures in the range from 20 MPa to 50 MPa are used, for example, during the diffusion joining of hard metals or metal matrix composite materials.

It is in accordance with the invention if the minimum pressure which is applied at the joining plane by means of the pressure variation is between 25% and 75% of the maximum pressure. A range between 40% and 60% is preferably chosen. This corresponds substantially to a movement of the first stamp in the range from 5 μm to 50 μm.

Such a variation of the pressure is particularly well suited to break up the oxide layers without hereby interrupting the basic above-described processes which occur during the joining. This would be the case if the pressure were not to be applied completely for some time.

It is advantageous if an upper stamp is chosen as a first stamp and a lower stamp is chosen as a second stamp. The choice of the upper stamp as a movable stamp via which the pressure and the pressure variation are introduced makes the construction of a device for diffusion joining easier since, if the lower stamp is fixed, the joining components can be laid more simply on the latter.

The pressure variation can be carried out in any desired way. It is advantageous if a cyclic pressure variation is provided. Here, various pressure forms, for example sinusoidal or step-like, are conceivable. Particularly good results have resulted with a sawtooth-like profile. This means that, here, the oxide layers can be broken up particularly well without prolonging the diffusion joining operations unnecessarily in this case. The sawtooth-like profile can have two substantially equal flanks. However, it is also possible to provide a very rapid rise with a continuous reduction in the pressure. In addition, an implementation with a continuous rise in the pressure and with an abrupt drop is possible and supplies good results.

The joining method can be used in particular for diffusion welding, diffusion soldering and/or for TLP diffusion welding. These methods can in principle be viewed as sub-types of diffusion joining. During diffusion welding, normally no additional material is provided on the joining plane between the two joining parts. By contrast, during diffusion soldering and TLP diffusion welding, a flux or the like is provided on the joining plane which, depending on the materials of the joining parts, permits a better connection than in pure diffusion welding.

In principle, the diffusion joining method according to the invention can be carried out with various materials such as metals, plastics and also combination materials.

According to the invention, a generic device is developed further by the second stamp being rigid and designed in the manner of an anvil. By contrast, the first stamp is designed and coupled to the pressure generating apparatus for applying the pressure and the pressure variation to the at least two joining parts, wherein the variation in the pressure is introduced in the pressing direction. Furthermore, the pressure generating apparatus is designed that the minimum pressure which is applied by means of the pressure variation lies between 25% and 75% of the maximum pressure.

Such a device is particularly well suited to carry out the method according to the invention. The device according to the invention ensures that the pressure variation which is introduced via the same stamp as the basic pressure also acts on the joining plane and here breaks up the oxide layers or contaminants efficiently. As a result of forming the second stamp as rigid and/or anvil-like, if the device is arranged in a chamber, the sealing problems of moving components, such as of the second stamp, can be dispensed with, since the latter substantially does not move.

It is advantageous if the pressure generating apparatus is designed to generate a pressure variation with a frequency of 0.5 Hz to 200 Hz. As already explained, it has transpired that a pressure variation having such a low frequency surprisingly permits efficient breaking up of the oxide layers and supposedly also therefore produces a particularly good connection between the two joining parts.

As already explained, the device according to the invention can be provided in a joining chamber, in which both the first and also the second stamp are arranged. In addition, a heating element, which is used to elevate the temperature in the joining chamber, can be incorporated in the joining chamber. Depending on the materials used, which are to be joined together or welded, different temperatures are advantageous as usual in order to accelerate the method or to produce an adequately stable connection. For example, aluminum alloys are preferably joined together in a chamber having a temperature between 400° C. and 600° C. Stainless steel is connected particularly well at a chamber temperature between 900° C. and 1100° C. Still harder metals or composite materials are to some extent also processed at temperatures above 1100° C.

In principle, the pressure generating apparatus which is coupled to one of the stamps can be designed as desired. It is suitable, for example, to design this mechanically, hydraulically and/or piezoelectrically to generate the pressure variation. If, as proposed according to the invention, relatively low frequencies are used, then a mechanical or hydraulic design is often sufficient and advantageous, since this is constructed more simply. A piezoelectric design, which in principle is also suitable for introducing higher frequencies, is not absolutely necessary but can likewise be used. Preferably, the pressure generating apparatus is an apparatus which applies both the basic pressure and also a variation, for example by varying the operating pressure.

The invention will be explained in more detail below by using a schematic exemplary embodiment with reference to the appended FIGURE, in which:

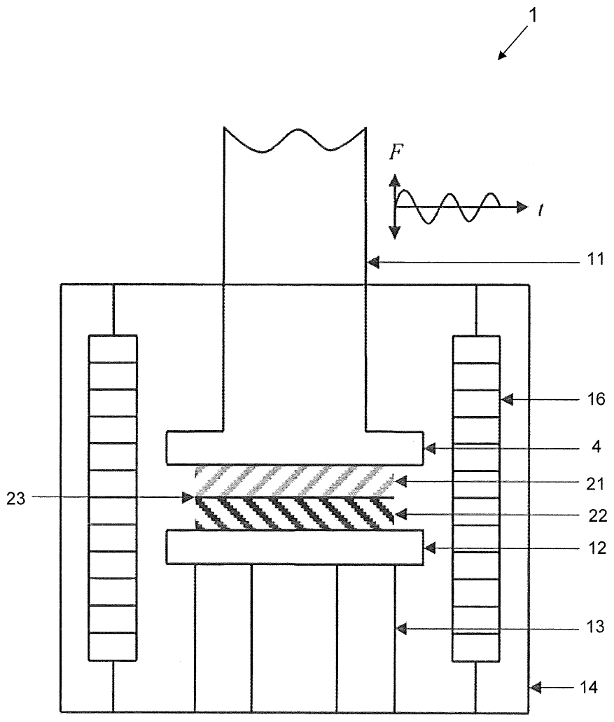

FIG. 1 shows a schematic section through a device according to the invention for diffusion joining.

FIG. 1 shows a highly simplified schematic illustration of a device according to the invention for diffusion joining.

This has, as essential components, a first stamp 11 and a second stamp 12. The second stamp 12 is arranged on a supporting structure 13. The first 11 and the second stamp 12 and the supporting structure 13 are enclosed by a reaction chamber 14. In addition, a heating element 16 is provided in the reaction chamber 14.

The device 1 according to the invention is, according to the invention, constructed in such a way that the second stamp 12 is arranged fixedly on the supporting structure 13. Only the first stamp 11 is movably provided. Via the latter, both a pressure and also a pressure variation can be applied.

In the chamber 14 itself, a vacuum can prevail, depending on the exact implementation of the diffusion joining method according to the invention. However, it is also possible to provide an inert gas atmosphere or else the normal atmosphere with a different or the same pressure as the ambient pressure.

In FIG. 1, two joining parts 21, 22 are provided between the first stamp 11 and the second stamp 12. These touch at their joining plane 23.

In the following, the method according to the invention will be explained in more detail by using the structure from FIG. 1.

After two joining parts 21, 22 have been arranged on the second stamp 12, which is the lower stamp in this embodiment, the first stamp 11 is moved onto the joining parts 21, 22. As soon as there is contact, pressure is further applied to the two joining parts 21, 22 via the first stamp 11.

In addition to a constant pressure, according to the teaching of the invention, a pressure variation is applied via the first stamp 11 to the two joining parts 21, 22 and in particular to the joining plane 23. By means of this pressure variation, it is possible to break up an oxide layer which exists on both joining parts 21, 22, in particular on the joining plane 23, so that a good and high-quality joining connection can be carried out. The production of the joining connection is improved in that, by means of the heating element 16, the temperature in the chamber 14 is elevated. Here, temperatures up to more than 1000° C. may be necessary.

It is advantageous in the design according to the invention that since the pressure and the pressure variation are introduced only via the first stamp 11, no two components which are moved actively and apply a pressure act against each other. In this way, the wear is reduced overall. In addition, designing the second stamp 12 is more simply possible, since the latter is not moved and can thus be arranged fixedly in the chamber 14 with the supporting structure 13.

According to the invention, the pressure variation is preferably introduced only with a frequency between 0.5 Hz and 200 Hz, advantageously in the range from 10 Hz to 20 Hz or around 100 Hz. Embodiments of this type make it possible to produce the application of the pressure difference even by simple, rapid mechanical movement of the first stamp 11 up and down. In principle, however, other possibilities for this are also conceivable, for example a mechanical imbalance can be provided or else the pressure can be varied smoothly hydraulically.

By using the method according to the invention and the device according to the invention, is thus possible to provide a simple structure and nevertheless to specify a method that can be applied efficiently, which produces a high-quality connection of two joining parts.

1.-10. (canceled)

11. A method for diffusion joining by using a first and a second stamp,
wherein at least two plate-like joining parts are arranged between the first and the second stamp with a joining plane between the at least two joining parts, wherein, for diffusion joining, by means of the first and/or the second stamp, a pressure is applied perpendicular to the joining plane to the at least two joining parts, and
wherein a pressure variation is additionally applied to the pressure,
wherein the pressure and the pressure variation are applied to the at least two joining parts via the first stamp,
wherein the pressure variation is introduced in the pressing direction,
wherein the second stamp is used as a rigid anvil-like stamp,
characterized
in that the minimum pressure which is applied by means of the pressure variation is chosen to be between 25% and 75% of the maximum pressure, in that the frequency of the pressure variation is chosen in the range from 10 Hz to 20 Hz, and in that the pressure and also the pressure variation are applied by an apparatus.

12. The method as claimed in claim 11, wherein the amplitude of the pressure variation 5 μm to 50 μm.

13. The method as claimed in claim 11, wherein the first stamp is chosen as an upper stamp and in that the second stamp is chosen as a lower stamp.

14. The method as claimed in one of claim 11, wherein the pressure variation is a cyclic pressure variation.

15. The method as claimed in one of claim 11, wherein the method is used for diffusion welding, diffusion soldering and/or TLP diffusion welding.

16. A device for diffusion joining, comprising a first and a second stamp, wherein at least two plate-like joining parts can be arranged between the first and the second stamp with a joining plane between the least two joining parts,
comprising a pressure generating apparatus for applying a pressure perpendicular to the joining plane to the at least two joining parts by means of the first and/or the second stamp,
wherein the pressure generating apparatus is designed to introduce the variation of the pressure in the pressing direction,
wherein the second stamp is rigid and designed in the manner of an anvil,
wherein the first stamp is designed and coupled to the pressure generating apparatus for applying the pressure and the pressure variation to the at least two joining parts,
wherein the pressure generating apparatus is designed to apply the pressure and also to vary the pressure, in that the pressure generating apparatus is designed that the minimum pressure which is applied by means of the pressure variation lies between 25% and 75% of the maximum pressure, and
the pressure generating apparatus can generate a pressure variation with a frequency of 10 Hz to 20 Hz.

17. The device as claimed in claim 16, wherein a joining chamber is provided, in which the first and the second stamp are arranged, and in that a heating element is provided in the joining chamber.

18. The device as claimed in claim 16, wherein the pressure generating apparatus is designed for the mechanical, hydraulic and/or Piezo electric generation of the pressure variation.
